(19) United States
(12) Patent Application Publication
(10) Pub. No.: US 2005/0075145 A1
(43) Pub. Date: Apr. 7, 2005

(54) Method and system for coordinating use of objects using wireless communications

(76) Inventors: Joseph L. Dvorak, Boca Raton, FL (US); Pablo Meles, Weston, FL (US); Kevin Michael Teehan, Mundelein, IL (US)

Correspondence Address: AKERMAN SENTERFITT, P.O. BOX 3188, WEST PALM BEACH, FL, 33402-3188, US

(21) Appl. No.: 10/678,487

(22) Filed: Oct. 3, 2003

(51) Int. Cl. H04M 1/00

(52) U.S. Cl. 455/572; 340/10.1; 235/375

(57) ABSTRACT

A system (10) for coordinating the use of objects together can include a tag (11) on a first object (18), a tag (19) on at least a second object (9), and a portable communication device (12) having a processor. The processor is preferably programmed to read information from the tag on the first object and from the tag on at least the second object, retrieve data (15) associated with the first object and at least the second object, and retrieve rules (14) relating to the use of the first object the second object. The rules can be fashion, food, drug or other coordination rules. The processor can also be programmed to apply the rules and provide feedback to the individual. The portable communication device can further include a bar code scanning device or alternatively a transceiver for reading information from RFIDs.

### CROSS-REFERENCE TO RELATED APPLICATIONS

Not applicable

### FIELD OF THE INVENTION

This invention relates generally to object coordination, and more particularly to a system and method for coordinating the use of objects together using wireless technology.

### BACKGROUND OF THE INVENTION

For those who are blind, vision impaired, or simply lack a good sense of fashion, putting together an ensemble of clothing that adheres to a set of fashion guidelines can be a challenge. For the blind or visually impaired it is especially challenging and they usually require assistance of another person in selecting the clothing or rely on Braille encoded tags. Likewise, many people on prescription drugs or who generally have a poor sense of what combination of foods go together fail to have the appropriate guidance before they ingest the food or drug. Even selecting a particular wine to go with a predetermined meal can be a challenge for most people. Currently, unless one has the appropriate knowledge or experience, coordination of the use of such combination of objects is generally left to chance or done in a tedious mechanical fashion. Thus, a relatively simple alternative system and method of coordinating the use of objects that overcomes the detriments described above using wireless communication would be desired.

### SUMMARY OF THE INVENTION

In a first aspect of an embodiment of the present invention, a method for coordinating a suitability of using objects together can include the steps of reading information from a first object and at least a second object to be used by an individual, retrieving data associated with the first and second object, and applying rules indicating the suitability of using the first object with at least the second object. The first and second object can be articles of clothing or drug containers or the drugs themselves. The steps of reading information can include reading from a barcode or from a radio frequency identifier as examples. The step of retrieving can retrieve data from a remote server via a wireless network connection. The step of applying rules indicating the suitability can include the step of applying fashion rules to the information retrieved from the first object and at least the second object, or applying drug rules that indicate the suitability of using particular drugs or any other rule set. Note further that any given rule set can preferably be customized by the user.

In a second aspect, a system for coordinating the suitability of using objects together can include a tag on a first object to be used by an individual, a tag on at least a second object to be used by the individual, and a portable communication device having a processor. The processor is preferably programmed to read information from the tag on the first object and from the tag on at least the second object, retrieve data associated with the first object and at least the second object, and retrieve rules relating to the use of the first object and at least the second object. The rules can be fashion, food, drug or any other coordination rules. The processor can also further be programmed to apply the rules to the use of the first object and at least the second object and provide feedback to the individual. The portable communication device can further include a bar code scanning device for scanning bar codes on at least one among the first object and the second object or alternatively a transceiver for reading information wirelessly from radio frequency identification tags coupled to the objects.

In a third aspect, an embodiment in accordance with the present invention can include a portable communication device having of a means for reading information from a tag on a first object and from a tag on at least a second object, a means for retrieving data associated with the first object and at least the second object, a means for retrieving rules relating to the use of the first object and at least the second object, a means for applying the rules to the use of the first object and at least the second object, and a means for providing feedback regarding use of the first object and at least the second object.

### BRIEF DESCRIPTION OF THE DRAWINGS

FIG. 1 is a block diagram of a system for coordinating fashions in accordance with the present invention.

FIG. 2 is a flow chart illustrating a method of coordinating fashions in accordance with the present invention.

FIG. 3 is a block diagram of a system for coordinating drug usage in accordance with the present invention

FIG. 4 is a flow chart illustrating a method of coordinating drug usage in accordance with the present invention.

### DETAILED DESCRIPTION OF THE DRAWINGS

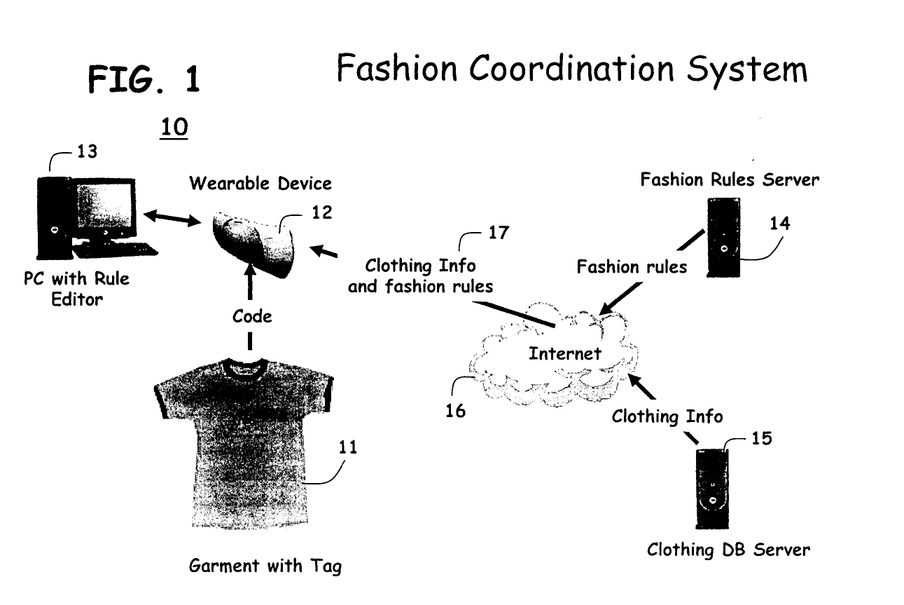

Referring to FIG. 1, a system 10 for coordinating the suitability of using objects together can include a tag 18 on a first object 11 to be used by an individual, a tag 19 on at least a second object 9 to be used by the individual, and a portable communication device 12 having a processor. The processor is preferably programmed to read information from the tag 18 on the first object 11 and from the tag 19 on at least the second object 9, retrieve data associated with the first object and at least the second object, and retrieve rules 17 relating to the use of the first object 11 and at least the second object 9. The rules can be fashion, food, drug or any other coordination rules. The information on the objects can be retrieved from a remote data base on a server 15 while the rules can be retrieved from a remote server 14. Retrieval can be achieved via the internet 16. Furthermore, the rules applied can be customized or altered using a computing device 13 such as a personal computer, personal digital assistant or other device having a rule editor. In other words, an application on the user's computing device 13 can allow him or her to modify (add, delete, modify) the rules in the set to reflect the user's own unique sense of fashion.

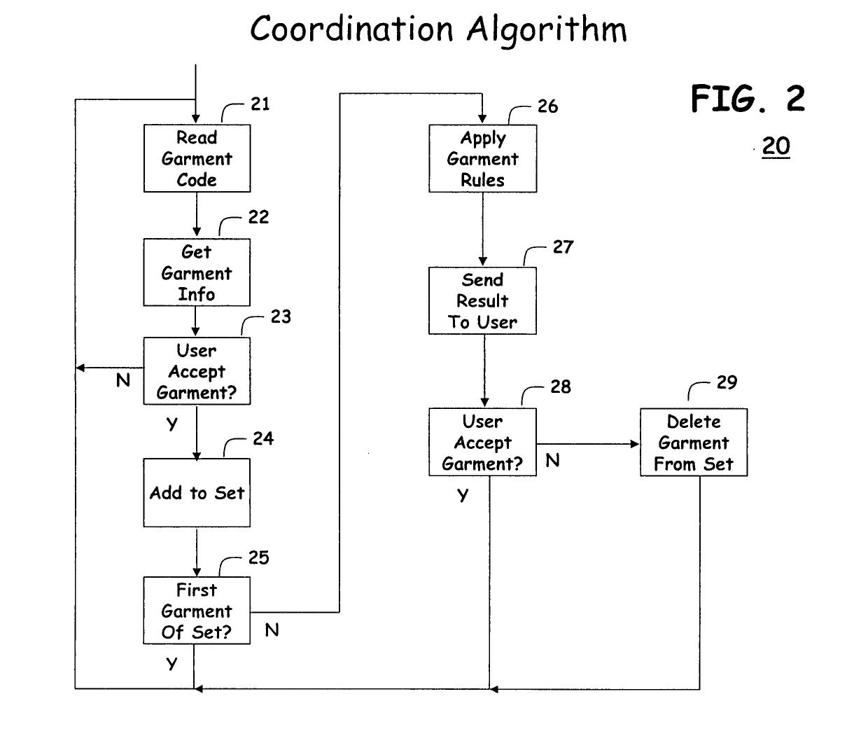

Referring to FIG. 2, a flow chart of a method 20 of fashion coordination is shown. The user can hold the clothing next to the device (such as portable communication device 12) to read the clothing's tag at step 21. The device 12 accesses the clothing's information (type, style, color, etc) at step 22 and renders this to the user. If the user wishes to accept this piece of clothing at step 23, it is added to the clothing ensemble set at step 24. Otherwise, it is ignored and the method 20 returns to step 21. At step 25, if the user accepts and this is not the first article in the set, the portable communication device applies the fashion rules to the set with the new garment added at step 26. It renders the result (what goes with what, what rules have been violated, etc) to the user at step 27. At this decision point 28, the user can optionally accept the garment and return to step 21 to await the reading of other garment tags or delete the garment from the set at step 29.

Thus, with the method described above in mind, the processor can be programmed to apply the rules when using the first object and at least the second object and provide feedback to the individual. The portable communication device 12 can further include a bar code scanning device for scanning bar codes on at least one among the first object and the second object or alternatively a transceiver for reading information wirelessly from radio frequency identification tags coupled to the objects.

Referring to FIG. 1 and the specific example relating to clothing or garments as in system 10, the tags can be passive electronic tags encoding an ID unique to the class of clothing such as an RFID device. The class of clothing can be the clothing's SKU or any other code that is associated with the item's type (e.g. pants, shirt). The portable communication device 12 can be a wearable device with a wireless transceiver that activates the clothing's tag and reads the clothing's ID. This device can also contain the processing and storage capabilities to host and access the clothing database 15 described above and/or a wireless wide area cellular transceiver capable of accessing the database on a remote server. The database entry for clothing information can be accessed via the clothing's ID code as the key. The database can alternatively be on the portable communication device 12 or at a remote server accessible over the internet as shown.

With respect to the rules, a set of rules encoding fashion guidelines in a form readable and processable by the portable communication device 12 should be rendered and otherwise presented in a human readable form. The portable communication device can also include a software application that that applies the fashion rules to the clothes the user selects and can further indicate a level of compliance with the rules. The compliance indication can be visual on a output device or can be rendered as speech. By using the rules of fashion applied to the clothing the user is selecting, the user is assisted in constructing a clothing ensemble that will be considered fashionable. This relieves the visually impaired or blind of the necessity for help from another person. In addition, the rules can be rendered in human readable form and the user can alter (modify, delete, add) the set to reflect their own unique sense of style. This system can easily be hosted on today's emerging smart phones along with the RFID technology that is being productized by several companies.

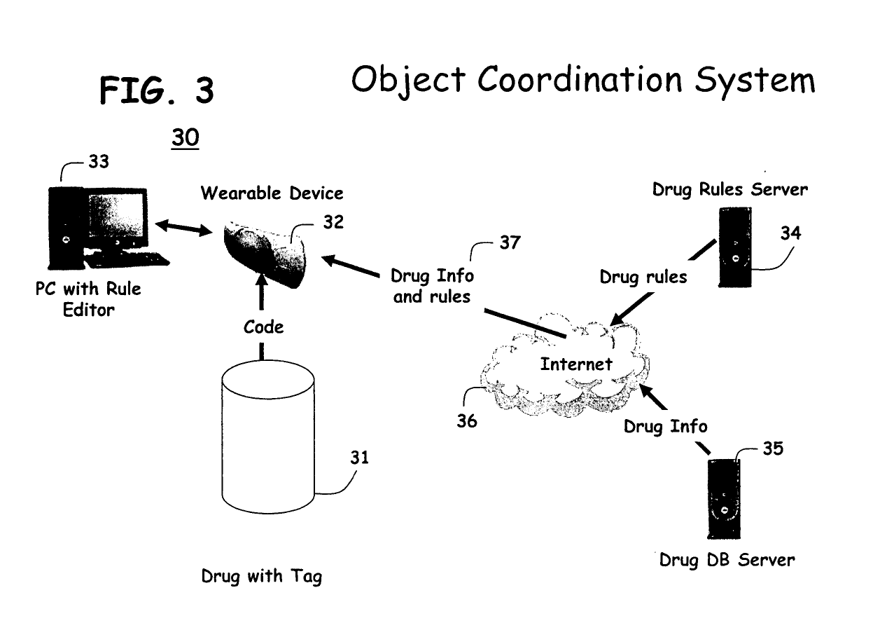

Referring to FIG. 3, a system 30 for coordinating the suitability of using objects together can include a tag on a first object 31 to be used by an individual, a tag on at least a second object 38 to be used by the individual, and a portable communication device 32 having a processor. The processor is preferably programmed to read information from the tag on the first object 31 and from the tag on at least the second object 38, retrieve data associated with the first object and at least the second object, and retrieve rules 37 relating to the use of the first object 31 and at least the second object 38. The rules in this particular instance can be drug coordination rules indicating whether certain drugs can be used with each other or with other food items for example. The information on the objects can be retrieved from a remote data base on a server 35 while the rules can be retrieved from a remote server 34. Retrieval can be achieved via the internet 36. Furthermore, the rules applied can be customized or altered using a personal computer 33 or other computing device having a rule editor as previously described. An application on the user's PC or a personal digital assistant for example can allow them to modify (add, delete, modify) the rules in the set to reflect the user's own experience with respect to foods. Of course, a user is highly recommended to consult a doctor to confirm any recommendations and before customizing their own rules. If desired, the rules engine can also have a mode where any rule modification is sent to a controlling entity (e.g., one's primary physician) who must approve any such changes before they take effect.

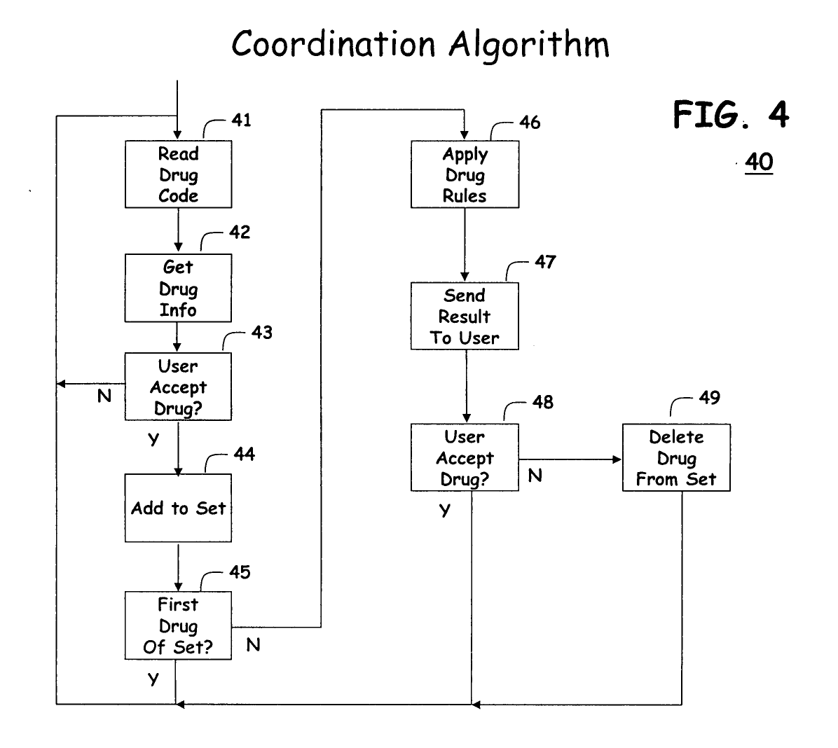

Referring to FIG. 4, a flow chart of a method 40 of drug coordination is shown. The user can hold the drug or drug container next to the device (such as portable communication device 12) to read the drug's tag at step 41. The device 12 accesses the drug's information (type, dosage, brand, etc) at step 42 and renders this to the user. If the user wishes to accept this particular drug at step 43, it is added to the drug set at step 44. Otherwise, it is ignored and the method 40 returns to step 41. At step 45, if the user accepts and this is not the first drug in the set, the portable communication device applies the drug rules to the set with the new drug added at step 46. It renders the result (what goes with what, what rules have been violated, etc) to the user at step 47. At this decision point 48, the user can optionally accept the drug and return to step 41 to await the reading of other drug tags or delete the drug from the set at step 49.

In light of the foregoing description of the invention, it should be recognized that the present invention can be realized in hardware, software, or a combination of hardware and software. A method and system for coordinating use of objects using wireless communications according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. A computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

1. A method for coordinating a suitability of using objects together, comprising the steps of:
reading information from a first object to be used by an individual;
retrieving data associated with the object;
reading information from at least a second object to be used by an individual;
retrieving data associated with at least the second object;
applying rules indicating the suitability of using the first object with at least the second object.

2. The method of claim 1, wherein the first object and at least the second object are articles of clothing.

3. The method of claim 1, wherein the first object and at least the second object are drug containers.

4. The method of claim 1, wherein the steps of reading information from the first object and from at least the second object comprises reading information from a barcode on a label associated with at least one among the first object and at least the second object.

5. The method of claim 1, wherein the steps of reading information from the first object and from at least the second object comprises wirelessly reading information from a radio frequency identifier tag associated with at least one among the first object and at least the second object.

6. The method of claim 1, wherein the steps of retrieving data for the first object and retrieving data for at least the second object comprises retrieving data from a remote server via a wireless network connection.

7. The method of claim 1, wherein the step of applying rules indicating the suitability comprises the step of applying fashion rules to the information retrieved from the first object and at least the second object.

8. The method of claim 1, wherein the method further comprises the step of customizing the rules that are applied to indicate the suitability of using the first object with at least the second object.

9. A system for coordinating the suitability of using objects together, comprising:
a tag on a first oject to be used by an individual;
a tag on at least a second object to be used by the individual; and
a portable communication device having a processor programmed to: read information from the tag on the first object and from the tag on at least the second object;
retrieve data associated with the first object and at least the second object;
retrieve rules relating to the use of the first object and at least the second object;
apply said rules to the use of the first object and at least the second object; and
provide feedback to the individual.

10. The system of claim 9, wherein the portable communication device further comprises a bar code scanning device for scanning bar codes on at least one among the first object and the second object.

11. The system of claim 9, wherein the tag on the first object and the tag on at least the second object are radio frequency identification tags and the portable communication device further comprises a transceiver for reading information wirelessly from the radio frequency identification tags.

12. The system of claim 9, wherein the system further comprises a connection to a remote server containing at least one among a database having the data associated with the first object and at least the second object and a database containing the rules relating to the use of the first object and at least the second object.

13. The system of claim 9, wherein the system further comprises a computing device that can communicate with the portable communication device and further including a rule editor program enabling customization of the rules by the individual.

14. The system of claim 9, wherein the system is a fashion coordination system, the first object and at least the second object are garments, and the rules are fashion rules.

15. The system of claim 9, wherein the system is a food coordination system and the first object and the second object are ingestible items.

16. The system of claim 9, wherein the system is a drug coordination system and the first object and the second object are drugs, and the rules analyze the suitability of using the drugs together.

17. A portable communication device, comprising:
means for reading information from a tag on a first object and from a tag on at least a second object;
means for retrieving data associated with the first object and at least the second object;
means for retrieving rules relating to the use of the first object and at least the second object;
means for applying said rules to the use of the first object and at least the second object; and
means for providing feedback regarding use of the first object and at least the second object.

18. The portable communication device of claim 17, wherein the means for reading information is selected from the group comprising a bar-code scanner, a RFID Tag reader, a Bluetooth transceiver, and a radio receiver.

19. The portable communication device of claim 17, wherein the means for retrieving data comprises a connection to a remote server containing data associated with the first object and at least the second object.

20. The portable communication device of claim 17, wherein the means for retrieving rules comprises a connection to a remote server containing rules relating to the use of the first object and at least the second object.

21. The portable communication device of claim 17, wherein the means for providing feedback is selected from the group comprising a display, a speaker, and a tactile alerting system.
